(19) United States
(12) Patent Application Publication
(10) Pub. No.: US 2019/0271168 A1
(43) Pub. Date: Sep. 5, 2019

(54) Negative-Side Water Proofing for Preexisting Building Structures Subject to Water Intrusion

(71) Applicant: Richard N. Clark, Deerfield Beach, FL (US)

(72) Inventor: Richard N. Clark, Deerfield Beach, FL (US)

(21) Appl. No.: 15/911,435

(22) Filed: Mar. 5, 2018

(51) Int. Cl. E04G 23/02; E04B 1/64; E04B 1/66; B32B 3/26; B32B 3/18; B32B 7/12; B32B 15/085; B32B 15/20; B32B 13/12; B32B 27/08; B32B 27/32

(52) U.S. Cl. CPC E04G 23/02; E04B 1/64; E04B 1/665; B32B 3/26; B32B 3/18; B32B 7/12; B32B 2419/00; B32B 15/20; B32B 13/12; B32B 27/08; B32B 27/32; B32B 2307/7265; B32B 2607/00; B32B 15/085

(57) ABSTRACT

A negative-side waterproof shell (W-shell) is retrofitted onto a below ground preexisting building subject to water intrusion. The W-shell includes a high density polyethylene (HDPE) membrane adhered to the building's sidewalls and floor. The HDPE membrane has a metal core (usually aluminum). The W-shell includes a concrete shell formed on an inboard side of the HDPE membrane. Typically, the W-shell's concrete typically includes rebar and supplemental vertical columns which are thicker than the W-shell. The HDPE membrane has overlapped seams at the vertical to horizontal transition regions. The core may be non-continuous, in strips, or may be ferrous or non-ferrous metals, alloys or aluminum alloys. The W-shell covers the building's interior concrete-formed structures. To seal high tide salt water intrusion, the W-shell extends above the high tide water line. Also, drain piping, leading to a sump, may be laid between the membrane and the floor.

The present invention relates to negative-side waterproofing for a preexisting building structure which is subject to water intrusion. Additionally, the present invention relates to a high density polyethylene (HDPE) membrane adapted for use in a negative side waterproof shell for a preexisting building structure subject to water intrusion.

### BACKGROUND OF THE INVENTION

Certain buildings have building structures or sub-structures that are below ground level or grade level and are sometimes subject to water intrusion. As an example, high-rise buildings on the barrier island of Miami Beach, Fla., often times have lower level parking structures that are below ground. Studies show that the level of the nearby ocean is rising. The rising level of ocean salt water (which may be either saltwater or brackish water) forces water into these below ground building structures. This water intrusion is caused by either hydrostatic force (water acting on the vertical side walls of these below ground building structures) or water intrusion by hydraulic or buoyant force acting on the floor of the below ground building structures. This problem of water intrusion in below ground building structures becomes a larger problem due to the rising levels of high tides and, more significantly, by the higher than normal tide levels during king tide periods which occur during certain months of the year. As is well known, the high tide may last two-three hours, twice per day. Therefore, the static water pressure on these below ground building structures, such as parking garages, is substantially higher during these twice-a-day high tide periods.

From an economic standpoint, buildings having these below ground structures subject to water intrusion are adversely impacted by flooding in parking garages and below ground storage rooms. For example, with respect to water intrusion in below ground parking garages in Miami Beach, Fla., experts estimate that nearly 400,000 vehicle parking spaces are flooded during the three-four king tide periods which affect Miami Beach. During these extraordinarily high tidal periods, vehicles in these below ground parking garages must be moved and placed in aboveground parking garages or on the street level. Also, due to the high price of these commercial and residential buildings on Miami Beach, experts have estimated that the cost to rebuild these below ground parking garages is extraordinarily high. For example, some experts have estimated that the cost of rebuilding a 100,000-150,000 sq.ft. below ground parking garage to be about $50,000,000-70,000,000. This cost of rebuilding the below ground parking garage significantly adversely affects the value of the entire building structure, not only the below ground parking facilities, but also the entire above ground building structure.

Therefore, there is a need for renovating and retro-fitting these below ground building structures which are subject to water intrusion.

### OBJECTS OF THE INVENTION

It is an object of the present invention to provide a negative-side waterproof shell for a preexisting building structure which is subject to water intrusion.

It is a further object of the present invention to provide a negative-side waterproof shell that can be retroactively installed in a below ground preexisting building structure which is subject to water intrusion.

It is an additional object of the present invention to utilize a high density polyethylene (HDPE) membrane, having a metal or polymer encased therein, and covered by an inboard or inside-facing concrete shell thereby providing a waterproof shell on the walls and floor of the preexisting building, the waterproof shell having an extraordinarily low permeance level.

### SUMMARY OF THE INVENTION

The negative-side waterproof shell is retrofitted into a preexisting building structure subject to water intrusion through the building sidewalls and the below grade or below ground floor. The waterproof shell includes a high density polyethylene (HDPE) membrane adhered to the vertical sidewalls and the floor subject to the water intrusion. The HDPE membrane has a metal or polymer core. The waterproof shell further includes an inboard concrete shell formed on an inboard side of the HDPE membrane. In most installations, the HDPE membrane is adhered with an adhesive (preferably a double sided tape) and the concrete shell includes rebar. When the sidewalls of the building (such as an underground garage) include vertical sidewalls rising above the floor, the vertical portions of the waterproof shell include a plurality or a number of periodic columns. The waterproof shell formed by the HDPE membrane and the concrete shell on the building's vertical sidewalls have a substantially uniform thickness. The thickness of the periodic columns is greater than the uniform shell thickness.

Typically, the metal core in the HDPE membrane is a layer or a sheet of metal encased in the HDPE membrane. This is preferably aluminum or an aluminum alloy. A non-ferrous metal or an non-ferrous metal alloy may sometimes be used. A polymer core may also be used, for example, as a resin core. To ensure a watertight seal, the HDPE membrane has overlapped seams formed at the vertical to horizontal transition regions of the building structure, usually thermo-sealed. Potentially, the metal or polymer core may be non-continuous in the HDPE membrane, such as a plurality of strips or an open-framework matrix encased in the HDPE membrane.

If the preexisting building structure includes interior concrete-formed structures rising above the floor, the waterproof shell covers portions of the outer wall building structures, the floor and the interior concrete-formed structures.

If the preexisting building structure is subject to high tide salt water intrusion, the waterproof shell has an HDPE membrane extending above the high tide water line.

The invention also relates to a high density polyethylene (HDPE) membrane adapted for use in a negative-side waterproof shell for a preexisting building structure subject to water intrusion. Due to water transference through the building sidewalls and floor, the HDPE membrane is adapted to be disposed between each the sidewall and a respective inboard sidewall concrete shell layer. The membrane includes a first and a second layer of HDPE encasing a metal or polymer layer interposed between the first and second layers to form a cored HDPE membrane. The cored HDPE membrane is formed into HDPE sheets. The HDPE sheets are adapted to be adhered to the building sidewalls prior to application of the inboard sidewall concrete shell layer.

The negative-side waterproof shell may also include perforated tubing interposed (a) beneath the HDPE membrane at least one vertical to horizontal transition region of a plurality of vertical to horizontal transition regions formed by the sidewalls and the floor; or (b) atop the floor and beneath the HDPE membrane. This perforated tubing fluidly coupled to a sump in the preexisting building structure permitting extraction of water beneath the HDPE membrane.

### BRIEF DESCRIPTION OF THE DRAWINGS

Further objects and advantages of the present invention can be found in the detailed description of the preferred embodiments when taken in conjunction with the accompanying drawings.

FIG. 1 diagrammatically illustrates a vertical or elevational cross-sectional view of a negative side waterproof shell applied to a preexisting building structure subject to water intrusion (building structure and elements of waterproof shell not to scale).

FIG. 2 is an enlarged view of region A′ in FIG. 1 and shows details of the waterproof shell (not to scale).

FIG. 3 is a further enlarged view of the high density polyethylene (HDPE) membrane in the region A″ of FIG. 2 (not to scale).

FIG. 4 diagrammatically shows a process flowchart describing the process of installing the negative-side waterproof shell.

FIG. 5 diagrammatically illustrates a horizontal cross-sectional view of a portion of a sidewall covered by the negative-side waterproof shell including vertical columns formed in the concrete shell (FIG. 1 being a vertical cross-sectional view of the negative-side waterproof shell) (not to scale).

FIG. 6 is a vertical cross-sectional view of the negative-side waterproof shell applied to both the outside sidewalls of the preexisting structure and applied to the interior concrete structures in the pre-existing building (not to scale).

FIG. 7 is a broken away, perspective view of the negative-side waterproof shell on sidewalls and floor and, more particularly a perforated or slot-bearing drainage tube in the vertical-to-horizontal transition between the sidewall and the floor which permits water which has seeped through the concrete beneath the HDPE membrane to be drained to a sump and sump pump drainage system. Many preexisting buildings have preexisting sumps and sump pump drainage systems. The use of a perforated tube between the HDPE and the adjacent floor is new.

FIG. 8 is a top view of a plan to install a perforated or slot-bearing drainage tube beneath the negative-side waterproof shell between the waterproof shell and the floor, thereby permitting seepage to be drawn-off to a sump and the preexisting sump pumping system.

### DETAILED DESCRIPTION OF THE PREFERRED EMBODIMENTS

The present invention relates to negative-side waterproofing for a preexisting building structure which is subject to water intrusion. Additionally, the present invention relates to a high density polyethylene (HDPE) membrane adapted for use in a negative-side waterproof shell for a preexisting building structure subject to such water intrusion. Similar numerals designate similar items throughout the drawings. Many of the drawings are not to scale but are illustrative of the various embodiments of the invention.

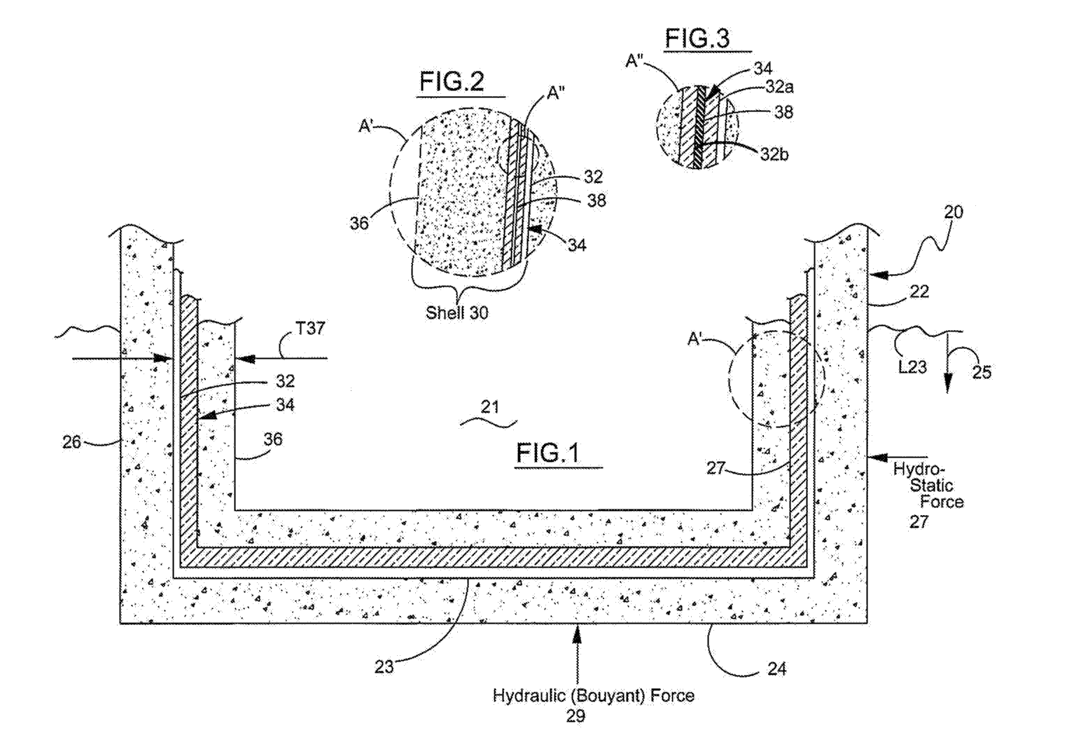

FIGS. 1, 2, and 3 are concurrently discussed herein. In FIG. 1, preexisting building structure 20 includes sidewalls 22, 26 and floor 24. The floor is structurally connected to sidewalls 22, 26. As known in the construction industry, the below ground building structure has an inboard region 21 and a number of additional sidewalls which are not shown in FIG. 1 but which define the structural boundaries of below ground, inboard region 21. Preexisting building structure 20 is subject to water intrusion when the water table rises above floor level 23. If building structure 20 is in a tidal region, it may be subjected to a high tide water level of L23. The level of water may drop down during the day as shown by arrow 25. Many structures along the U.S. coastline were built such that floor 24 was above the high tide water level. With the rise in ocean levels, higher water levels at L23 are subjecting these preexisting buildings to water intrusion into inboard area 21.

During high tide periods and at other times when the water table is above floor 24, the water table exerts a lateral hydrostatic force 27 on the sidewalls of preexisting structure 20 and hydraulic or buoyant vertical lifting force 29 acting on floor 24. Since concrete is hygroscopic, water transference is problematic. The problem of water intrusion is particularly associated with below ground concrete structures such as sidewalls 22, 26 and floor 24 in FIG. 1. As used herein, “water intrusion” includes “fresh water intrusion” and “salt water” intrusion and “brackish water” intrusion. For example, the rise in ocean levels has increased the fresh water level of the Hudson River in the lower Hudson River valley. Hydrostatic force is a force due to pressure of a fluid at rest such as the force exerted on a wall of a tank, dam, or ship or, in the case of a preexisting building structure, force 27 on the sidewall. It is also known in the building trade that concrete is hygroscopic in that the concrete absorbs water. Therefore, due to a rising water table affecting below ground or below grade building structures, whether that rising water is due to higher average ocean levels or due to the effect of daily high tides or due to the effect of extraordinarily high king tide levels or due to ay type of rising water table, when those below ground building structures are made of concrete, water intrusion is a continual problem. Due to the cost of rebuilding these below ground structures, there is a significant need for retrofitting these preexisting below ground or below grade building structures with negative-side waterproofing.

In summary, a high density polyethylene (HDPE) membrane 34 is adhered to the vertical sidewalls 22, 26 and floor 24 subject to such water intrusion. The HDPE membrane includes a metal or polymer core 38. The negative-side waterproof shell 30 includes, in the preferred embodiment, an adhesive layer 32, adhering the HDPE membrane 34 onto the vertical sidewalls and floor and concrete shell 36 placed on the inboard side 27 of the HDPE membrane 34. The term “inboard”, refers to items that are inside the below grade building structure. The term “outboard” refers to items that are outside that below grade building structure such as water at level L23. The adhesive layer in a preferred embodiment is a double-sided tape rated at 2 ATM pressure. Other adhesives may be used to adhere the metal-polymer-cored HDPE membrane to the sidewalls and the floor.

Preferably, the HDPE has fibers dispersed therein. The present embodiment of the invention has a metal-polymer-cored HDPE membrane thickness of about 38-42 mils thick. In a metal cored membrane, aluminum is used as the metal core of the HDPE membrane. In a polymer-cored membrane, resin is encased in the HDPE layers. The aluminum core is a layer or a sheet of metal encased by first and second HDPE layers 32a, 32b (FIG. 3) of the HDPE membrane. The metal core may be aluminum or aluminum alloy. Potentially other nonferrous metals or a nonferrous metal alloys may be used. Potentially, the metal core may be made of other types of materials. A wide variety of polymers may be used as the core of the HDPE membrane.

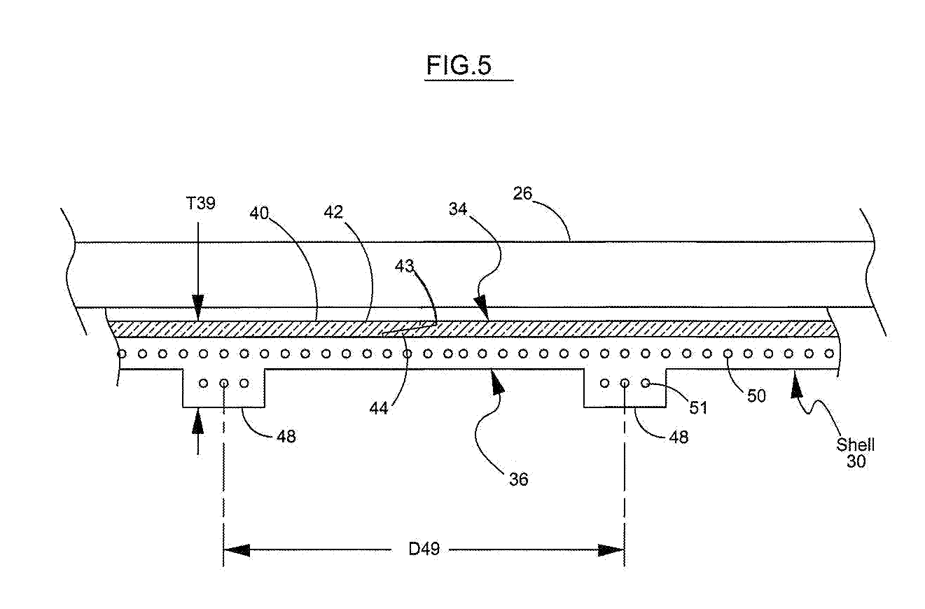

Once the HDPE plastic skin or membrane is adhered to the sidewalls 22, 26 and floor 24, a concrete shell 36 is formed on all inboard sides of the membrane or plastic skin. In a preferred embodiment, the HDPE membrane is formed in sheets 40, 42 (see FIG. 5). The sheets are adhered to the walls and floor.

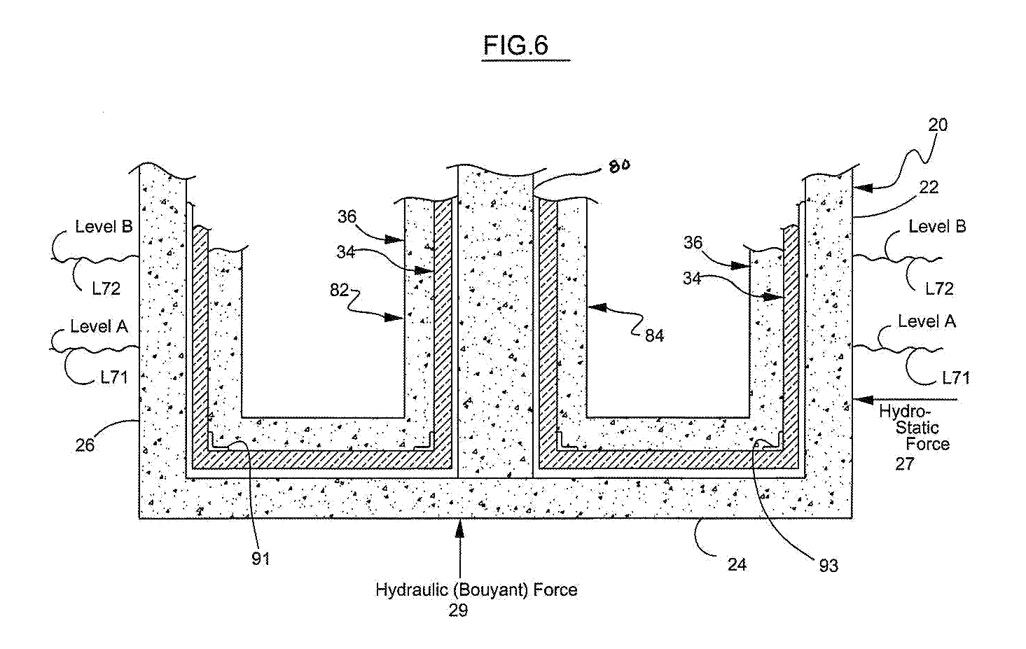

FIG. 5 shows a top or horizontal cross-sectional view of sidewall 26, and shows HDPE membrane sheet 40 having an edge 43 adjacent HDPE membrane sheet 42. The edge joint 43 between sheets 42, 40 is formed as an overlap joint 44 in FIG. 5. In FIG. 6, the joints between various HDPE sheets, particularly at the transition areas between the vertical runs and the horizontal run, have overlapped, thermo-sealed seams 91, 93. In a preferred embodiment, the HDPE membranes are folded over each other, then the folded material is covered by tape and then thermally sealed. Preferably, the HDPE thermal seal occurs at approximately 425° F. Each transition between a vertical membrane element and a horizontal membrane element has the same taped and heat sealed joint. Alternatively, the tape may be applied after the thermo-seal. Further, the joint 43 in FIG. 5 is also taped and heat sealed.

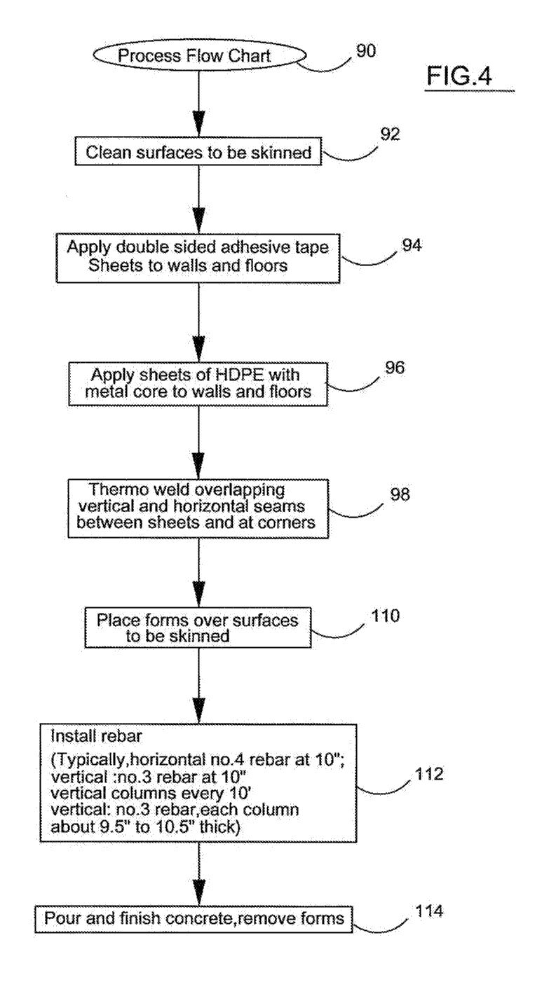

FIG. 4 diagrammatically shows a process flowchart 90 for the installation of the negative-side waterproof shell. In step 92, the inboard surfaces of the preexisting building structure is cleaned. In step 94, double-sided adhesive tape (in sheets or strips or a layer) is applied to the walls and floors of the preexisting below grade building structure. In step 96, sheets of HDPE membrane are applied to the walls and the floor of the below ground structure. In step 98, the overlapping edges or joints of the HDPE sheets, both the vertical and horizontal seams, are thermo-sealed. Tape may be additionally applied over the joints. In step 110, concrete shell forms are placed over the skinned sidewalls and floor surfaces. These forms are used to create the concrete shell 36. In step 112, rebar or reinforcing bar is installed in the concrete forms. In a preferred embodiment for horizontal runs, no. 4 rebar is used at 10 inch centers. For vertical sidewalls, no. 3 rebar is used at 10 inch centers. Further, vertical columns are placed in the sidewalls at 10 foot centers. These vertical columns use a cage of no. 3 rebar in each vertical column. Each vertical column is about 9.5 inches-10.5 inches thick. In step 114, the concrete is poured into the forms and finished. The forms are removed and any additional paint or markings are placed on the inboard surface of the concrete shell (for example, parking spot indicia). The rebar and columns are typically used based upon either local ordinance or engineering requirements. Other structures may require different rebar for the concrete shell.

FIG. 5 diagrammatically illustrates a horizontal cross-sectional view of the negative-side waterproof shell 30 placed on sidewall 26. The HDPE membrane 34 has two sheets of membrane material 40, 42 and an overlap thermally created seal 44 at joint 43. Rebar 50 is placed in the concrete shell 36. Vertical columns 48 are formed in the concrete shell for lateral stability. These columns are structural requirements by local ordinance or good engineering practice. In one embodiment, the columns are at 10 foot centers indicated by distance D49 in FIG. 5. The thickness T39 of the column in one embodiment 8.5 to 9.5 inches thick. In one embodiment, the total lateral thickness of the waterproof shell 30 along sidewalls 22, 26 (see FIG. 1) is shown as dimension T37 and is about 8 inches, not accounting for the column thickness. As is known in the construction industry, columns are typically required in order to provide lateral support for longer horizontal runs of concrete walls.

A typical thickness of floor 24 without the negative-side waterproof shell is about 3.0 to 3.5 inches thick. In order to maintain, for parking garages, an interior vertical clearance height or space, the negative-side waterproof shell atop floor 24 is about 3.5 inches thick. A typical interior vertical height clearance is about 9.0 to 9.5 feet. Local ordinance or good engineering practices dictate this vertical clearance.

It should be noted that the illustrated dimensions of the negative-side waterproof shell 30 in all the drawings, that is, the thickness of: pre-existing building structure 20, sidewalls 22, 26 and floor 24 and HDPE membrane 34, HDPE layers 32a, 32b, metal core 38, and concrete shell 36 are not shown to scale and are not proportional to each other. Although FIGS. 1, 2 and 3 show a metal core, a polymer core may be used. Stated otherwise, the illustrations herein are shown to identify the structural elements without concern of the actual dimensions and layers. The same is true regarding rebar placement in FIG. 5 and concrete column placement in FIG. 5.

FIG. 6 shows that the water table has a lower level A at level L71 and at a higher level B at level L72. Since it is known in the construction industry that concrete is hygroscopic, when interior walls and structures are included in these below grade or below ground pre-existing structures, interior concrete structures 80 are also subject to water intrusion. Typically, these interior concrete formed structures 80 are structurally connected to floor 24 as shown in FIG. 6. The waterproof shell 30, formed by HDPE membrane 34 and concrete shell 82, 84 covers portions of the outer wall structures 22, 26 and the interior concrete formed structures 80. It is recommended that the negative-side waterproof shell 30 extend above the higher water level B at level L72.

In the preferred embodiment, the water vapor permeance of the water proof shell 30 is 0.000000 perms.

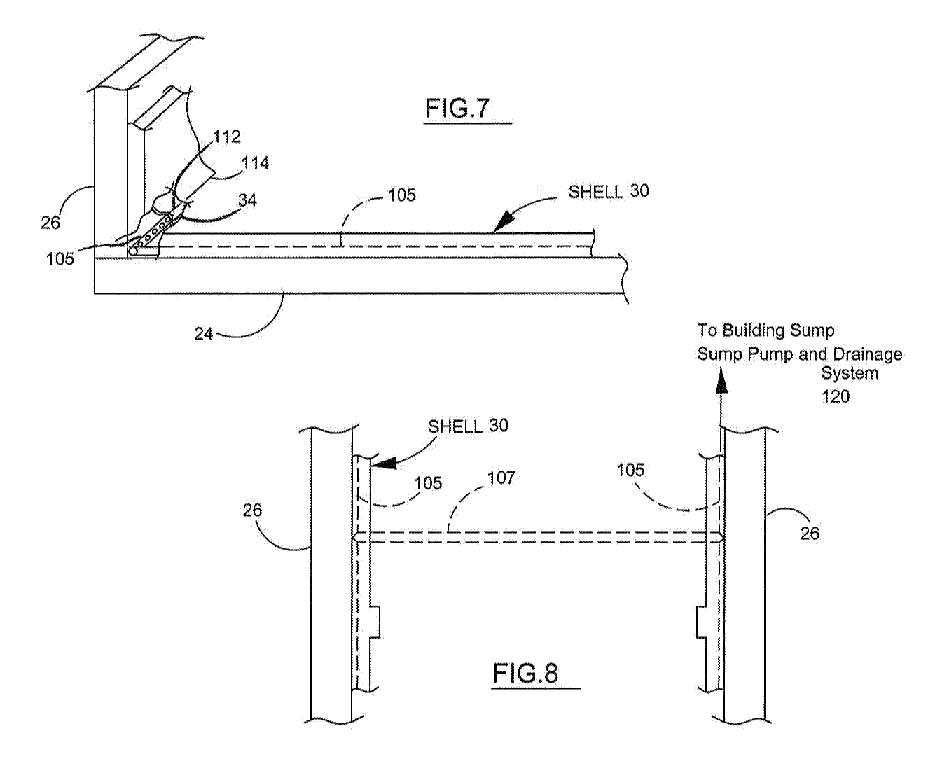

FIG. 7 is a broken away, perspective view of the negative-side waterproof shell 30 on sidewall 26 and floor 24. A perforated or slotted drainage tube 105 is placed in the vertical-to-horizontal transition between sidewall 26 and floor 24, that is, in the corner of the wall and the floor. The tube 105 permits water which has seeped through the concrete beneath the HDPE membrane 34 to be drained to a sump and sump pump drainage system (the sump diagrammatically shown in FIG. 8). Many preexisting buildings have preexisting sumps and sump pump drainage systems 120. The use of perforated tube 105 between the HDPE membrane 34 and the adjacent floor 24 is new. When membrane 24 traverses the tube 105, a small hump 112 is formed by overlaid membrane. However, the inboard concrete shell covers this small hump 112 as shown in concrete shell region 114 in FIG. 7.

FIG. 8 is a top plan view showing a perforated or slot-bearing drainage tube 107 beneath the negative-side waterproof shell and between the waterproof shell and the floor, thereby permitting seepage to be drawn-off to a sump and the preexisting sump pumping system. Drain tube 107 is laid on the preexisting floor at an intermediate location. The small hump (not shown) caused by the HDPE membrane passing over the tube 107 is covered by the inboard concrete shell. In a common below ground parking garage, the floor covered by the inboard concrete shell is substantially level and flat and the inboard concrete shell is slightly thinner atop the small tube-hump compared to the inboard concrete shell at other regions beyond the small tube-hump. FIG. 8 shows the intermediate slotted tube 207 is fluidly tied or coupled to corner slotted tube 105 and further fluidly coupled to the building's sump, sump pump and drainage system 120. Many, if not all, preexisting buildings have sumps, sump pumps and drainage systems. Slotted tubes 105, 107 are fluidly coupled to these systems 120.

The claims appended hereto are meant to cover modifications and changes within the scope and spirit of the present invention.

What is claimed is:

1. A negative-side waterproof shell for a preexisting building structure subject to water intrusion through sidewalls rising above a floor comprising:
an adhesive adhering a high density polyethylene (HDPE) membrane on said vertical sidewalls and said floor subject to said water intrusion, said HDPE membrane having a metal or polymer core; and
a concrete shell formed on an inboard side of said HDPE membrane.

2. A negative-side waterproof shell as claimed in claim 1 including
rebar in said concrete shell; and
wherein said sidewalls are substantially vertical sidewalls, and other than a plurality of periodic columns, said waterproof shell formed by said HDPE membrane and said concrete shell on said vertical sidewalls have a substantially uniform thickness, and a thickness of said periodic columns being greater than said uniform thickness.

3. A negative-side waterproof shell as claimed in claim 2 including perforated tubing interposed (a) beneath said HDPE membrane at least one vertical to horizontal transition region of a plurality of vertical to horizontal transition regions formed by said sidewalls and said floor; or (b) atop said floor and beneath said HDPE membrane;
said perforated tubing fluidly coupled to a sump in said preexisting building structure permitting extraction of water beneath said HDPE membrane.

4. A negative-side waterproof shell as claimed in claim 1 wherein said metal or polymer core is a layer or a sheet encased in said HDPE membrane.

5. A negative-side waterproof shell as claimed in claim 4 wherein membrane has a metal core of either aluminum or an aluminum alloy or a non-ferrous metal or an non-ferrous metal alloy.

6. A negative-side waterproof shell as claimed in claim 5 wherein said HDPE membrane and said concrete shell cover all said vertical sidewalls and said floor subject to said water intrusion up to an estimated high-water level.

7. A negative-side waterproof shell as claimed in claim 6 including overlapped seams formed by said HDPE membrane at a plurality of vertical to horizontal transition regions in said HDPE membrane and said concrete shell.

8. A negative-side waterproof shell as claimed in claim 4 wherein said metal or polymer core is non-continuous in said HDPE membrane.

9. A negative-side waterproof shell as claimed in claim 4 wherein said metal or polymer core is a plurality of strips or open framework encased in said HDPE membrane.

10. A negative-side waterproof shell as claimed in claim 1 wherein said preexisting building structure subject to water intrusion includes outer wall structures subject to water intrusion rising above said floor and includes interior concrete-formed structures rising above said floor;
said waterproof shell formed by said HDPE membrane and said concrete shell covering portions of said outer wall structures, said floor and said interior concrete-formed structures.

11. A negative-side waterproof shell as claimed in claim 7 wherein said preexisting building structure subject to water intrusion includes outer wall structures subject to water intrusion rising above said floor and includes interior concrete-formed structures rising above said floor;
said waterproof shell formed by said HDPE membrane and said concrete shell covering portions of said outer wall structures, said floor and said interior concrete-formed structures.

12. A negative-side waterproof shell for a preexisting building structure subject to high tide salt water intrusion through sidewalls and floor of said preexisting building structure, said preexisting building structure being subject to tidal salt water intrusion only during high tide periods, the negative-side waterproof shell comprising:
an adhesive adhering a high density polyethylene (HDPE) membrane on said vertical sidewalls and said floor subject to said high tide salt water intrusion, said HDPE membrane having a metal core; and
a concrete shell formed on an inboard side of said HDPE membrane.

13. A negative-side waterproof shell as claimed in claim 12 wherein said sidewalls are substantially vertical sidewalls, and other than a plurality of periodic columns, said waterproof shell formed by said HDPE membrane and said concrete shell on said vertical sidewalls have a substantially uniform thickness, and a thickness of said periodic columns being greater than said uniform thickness.

14. A negative-side waterproof shell as claimed in claim 12 wherein said metal core is a layer or a sheet of metal encased in said HDPE membrane.

15. A negative-side waterproof shell as claimed in claim 14 wherein said metal core is aluminum or an aluminum alloy or a non-ferrous metal or an non-ferrous metal alloy.

16. A negative-side waterproof shell as claimed in claim 15 wherein said HDPE membrane and said concrete shell cover all said vertical sidewalls and said floor subject to said water intrusion up to an estimated high-water level, said estimated high-water level including estimated king tide water levels.

17. A negative-side waterproof shell as claimed in claim 16 including overlapped seams formed by said HDPE membrane at a plurality of vertical to horizontal transition regions in said HDPE membrane and said concrete shell.

18. A negative-side waterproof shell as claimed in claim 15 wherein said metal core is non-continuous in said HDPE membrane.

19. A negative-side waterproof shell as claimed in claim 17 wherein said preexisting building structure subject to water intrusion includes outer wall structures subject to water intrusion rising above said floor and includes interior concrete-formed structures rising above said floor;
said waterproof shell formed by said HDPE membrane and said concrete shell covering portions of said outer wall structures, said floor and said interior concrete-formed structures.

20. A negative-side waterproof shell for a preexisting building structure subject to water intrusion through sidewalls rising above a floor comprising:
a high density polyethylene (HDPE) membrane adhered onto said vertical sidewalls and said floor subject to said water intrusion, said HDPE membrane having a metal or polymer core; and
a concrete shell formed on an inboard side of said HDPE membrane.

21. A negative-side waterproof shell as claimed in claim 20 wherein said metal or polymer core is a layer, a sheet, an open framework or a strip of metal or polymer encased in said HDPE membrane, and said core is aluminum or an aluminum alloy or a non-ferrous metal or an non-ferrous metal alloy or a polymer.

22. A negative-side waterproof shell as claimed in claim 21 including overlapped seams formed by said HDPE membrane at a plurality of vertical to horizontal transition regions in said HDPE membrane and said concrete shell.

23. A negative-side waterproof shell as claimed in claim 22 wherein said metal or polymer core is non-continuous in said HDPE membrane.

24. A high density polyethylene (HDPE) membrane adapted for use in a negative-side waterproof shell for a preexisting building structure subject to water intrusion through sidewalls rising above a floor, said membrane adapted to be disposed between each said sidewall and a respective inboard sidewall concrete shell layer, said membrane comprising:
a first and a second layer of HDPE encasing a metal layer interposed between said first and second layers to form an HDPE membrane with a metal core;
said HDPE membrane with said metal core formed into HDPE sheets;
wherein said HDPE sheets are adapted to be adhered to said sidewalls prior to application of said inboard sidewall concrete shell layer; and
wherein said sheets lay over one or more perforated tubes interposed (a) beneath said HDPE membrane at least one vertical to horizontal transition region of a plurality of vertical to horizontal transition regions formed by said sidewalls and said floor; or (b) atop said floor and beneath said HDPE membrane, said perforated tubes fluidly coupled to a sump in said preexisting building structure permitting extraction of water beneath said HDPE membrane.

25. A high density polyethylene (HDPE) membrane as claimed in claim 24 wherein said metal or polymer core is aluminum or an aluminum alloy or a non-ferrous metal or an non-ferrous metal alloy or a polymer.

26. A high density polyethylene (HDPE) membrane as claimed in claim 25 wherein said metal or polymer core is a layer, a sheet, an open framework or a strip of metal or polymer encased in said HDPE membrane, and said core is aluminum or an aluminum alloy or a non-ferrous metal or an non-ferrous metal alloy or a polymer.

27. A high density polyethylene (HDPE) membrane as claimed in claim 25 wherein said core is a metal core or aluminum or aluminum alloy formed as a plurality of strips encased in said HDPE sheet.
